(19) United States
(12) Patent Application Publication
(10) Pub. No.: US 2005/0211952 A1
(43) Pub. Date: Sep. 29, 2005

(54) Compositions and methods for chemical mechanical planarization of tungsten and titanium

(76) Inventors: Timothy Mace, Newark, DE (US); Brian L. Mueller, Middletown, DE (US); Charles Yu, Wilmington, DE (US)

Correspondence Address: Rohm and Haas Electronic Materials;CMP Holdings, Inc., Suite 13000, 1105 North Market Street, Wilmington, DE, 19899, US

(21) Appl. No.: 10/811,622

(22) Filed: Mar. 29, 2004

(51) Int. Cl. C09K 13/00; C23F 1/00; B44C 1/22

(52) U.S. Cl. 252/79.1; 252/79.2; 216/88; 216/89; 216/100

(57) ABSTRACT

The present invention provides an acidic aqueous composition useful for polishing tungsten and titanium on a semiconductor wafer comprising by weight percent 0.5 to 10 abrasive, 0.5 to 9 oxidizer, 0.1 to 5 complexing agent, 0.1 to 5 chelating agent and balance water, wherein the abrasive is fumed silica that has a surface area of greater than 90 m²/g and has only been exposed to an acidic pH.

### BACKGROUND OF THE INVENTION

The invention relates to chemical mechanical planarization or polishing (CMP) of semiconductor wafer materials and, more particularly, to CMP compositions and methods for polishing tungsten and titanium on semiconductor wafers,

As the requirement for increasing the density of active devices on an individual chip has escalated, the requirement for greater flatness on the active surfaces of the wafer has concurrently increased. A flat surface is desired for improved interconnect metallization to underlying layers and for improved ability to fill via holes and lines.

CMP is the foremost technique to achieve the desired flatness. CMP enhances the removal of surface material, mechanically abrading the surface while a chemical composition (“slurry”) selectively attacks the surface. Accordingly, a conventional CMP slurry exhibits different removal rates (“selectivity”) for at least two different materials on the wafer surface (e.g., different polish rates for metal relative to an interlayer dielectric).

Currently, CMP is the preferred method of polishing tungsten and titanium during formation of tungsten contact/via plugs. Generally, for this application, a contact/via hole is etched through a dielectric layer to expose regions of the underlying devices (for first-level metallization) or metal interconnects (for higher levels of metallization). A titanium “glue” layer is deposited onto the sides and bottom of the contact/via hole, and tungsten is deposited thereon. CMP is used to remove the deposited tungsten and titanium from the wafer surface, leaving tungsten plugs in the contact/via holes having surfaces coplanar with the exposed dielectric. Hence, a CMP slurry for tungsten processing should be highly selective for tungsten and titanium as compared to the dielectric. This selectivity allows for over-polishing while still achieving a flat tungsten plug surface.

Sethuraman et al., in U.S. Pat. No. 6,001,269, discloses a known abrasive composition for polishing a semiconductor device comprising an iodate-based oxidizer. The composition of Sethuraman provides selectivity of titanium relative to the oxide of about 18 (e.g., 2360 Å/min for Ti and 130 Å/min for oxide). Although, the composition of Sethuraman provides adequate selectivity, the ever-increasing density of integration in microelectronic circuits demands improved compositions and methods. In particular, the composition should provide improved removal of the titanium layer to increase clear times while suppressing the removal of the dielectric layer.

Hence, what is needed is a composition and method for chemical-mechanical polishing of tungsten and titanium having improved selectivity. In particular, what is needed is a composition and method that provide improved removal of the titanium layer while suppressing the removal of the dielectric layer.

### STATEMENT OF THE INVENTION

In a first aspect, the present invention provides an acidic aqueous composition useful for polishing tungsten and titanium on a semiconductor wafer comprising by weight percent 0.5 to 10 abrasive, 0.5 to 9 oxidizer, 0.1 to 5 complexing agent, 0.1 to 5 chelating agent and balance water, wherein the abrasive is fumed silica that has a surface area of greater than 90 m²/g and has only been exposed to an acidic pH.

In a second aspect, the present invention provides an acidic aqueous composition useful for polishing tungsten and titanium on a semiconductor wafer comprising by weight percent 0.5 to 10 abrasive, 0.5 to 9 iodate oxidizer, 0.1 to 5 potassium pyrophosphate, 0.1 to 5 lactic acid and balance water, wherein the abrasive is fumed silica that has a surface area of greater than 90 m²/g and has been dispersed and diluted entirely in an acidic pH.

In a third aspect, the present invention provides a method useful for polishing tungsten and titanium on a semiconductor wafer comprising: contacting the tungsten and titanium on the wafer with an acidic polishing composition, the polishing composition comprising by weight percent 0.5 to 10 abrasive, 0.5 to 9 oxidizer, 0.1 to 5 complexing agent, 0.1 to 5 chelating agent and balance water, wherein the abrasive is fumed silica that has a surface area of greater than 90 m²/g and has only been exposed to an acidic pH; and polishing the tungsten and titanium with a polishing pad.

### DETAILED DESCRIPTION OF THE INVENTION

The composition and method provide unexpected selectivity for removing tungsten and titanium relative to the dielectric layer. The composition advantageously relies upon an acidic pH only processed abrasive to suppress the removal of the dielectric layer. In particular, the composition comprises an acidic pH only processed fumed silica abrasive to selectively polish tungsten and titanium relative to the dielectric layer. Further, the composition comprises an acidic pH only processed fumed silica abrasive having a surface area greater than 90m²/g to selectively polish tungsten and titanium relative to the dielectric layer.

As used herein, an “acidic pH only processed abrasive,” “acidic pH only processed fumed silica,” “acidic abrasive,” and “acidic fumed silica,” are defined as an abrasive that has only been processed at an acidic pH. In other words, the abrasive was not dispersed or diluted in a basic solution at any point, including, the final formulation.

Advantageously, the solution contains, by weight percent, 0.5 to 10 fumed silica abrasive. Preferably, the solution contains, by weight percent, 3 to 8 fumed silica abrasive. Most preferably, the solution contains, by weight percent, 4.5 to 6.5 fumed silica abrasive.

In a preferred embodiment, the acidic fumed silica of the present invention is fabricated by initially charging a mixer with a predetermined volume of de-ionized water. Preferably, the mixer utilized is a high shear mixer, for example, a Myers Mixer manufactured by Meyers Engineering, Inc. of Bell, Calif. Fumed silica, for example, Aerosil 130 is commercially available from Degussa, of Parsippany, N.J2. Thereafter, a predetermined amount of acid is added to the water based upon the desired pH. After the addition of acid to the water, the mixer operates to mix the acid and water to form an acidic water solution. The acid may be a mineral or organic acid such as hydrochloric acid, sulfuric acid, nitric acid, phosphoric acid, acetic acid or maleic acid. Preferably, the acid is hydrochloric acid.

Advantageously, the quantity of acid added to the water is an amount, by weight percent, between 0.0010 and 0.50 of fumed silica that will be added to the water. Preferably, the quantity of acid added to the water is an amount, by weight percent, between 0.0015 and 0.15 of fumed silica that will be added to the water.

The initial quantity of water chosen is based on the amount of fumed silica to be added, and the desired final concentration of fumed silica in the aqueous dispersion. For example, if the desired final concentration of the aqueous dispersion of fumed silica is by weight percent 35 fumed silica, then the initial quantity of water is that quantity or concentration that will result in a greater than 35 weight percent fumed silica in the mixer. In the present invention, the dispersion will have a fumed silica concentration about 5 weight percent greater than the desired final concentration of fumed silica in the aqueous dispersion of fumed silica. Thereafter, the aqueous dispersion in the mixer will be diluted by the addition of an additional amount of water to achieve the desired final concentration of fumed silica.

Next, fumed silica is dispersed in the water-acid solution in the mixer to a predetermined concentration. Advantageously, the temperature of the solution is maintained at less than 60° C., preferably, less than 35° C. The fumed silica may be added by mixing the fumed silica into the water-acid mixture while the mixer is operating, or by adding the fumed silica to the water-acid mixture and then operating the mixer. The fumed silica may also be added incrementally, in a series of steps, with the mixer operating between each step. After the concentration of fumed silica in the aqueous dispersion has been raised to a point above the desired final concentration of fumed silica, the mixer is allowed to operate until the dispersion in the mixer reaches a desired viscosity. The high shear mixing breaks down the agglomerated structure of the dry fumed silica causing the viscosity to drop. Hence, the high shear mixing is maintained throughout the process to cause deagglomeration. If the mixer stops, the dispersion may gel and lock up the mixer and result in unwanted, larger particles in the dispersion. As discussed, the dispersion in the mixer, before dilution, will have a fumed silica concentration about 5 percent greater than the desired final concentration of fumed silica.

Advantageously, the aqueous dispersion contains, by weight percent, at least 35 fumed silica. Preferably, the aqueous dispersion contains, by weight percent, between 40 to 65 fumed silica. In addition, the fumed silica advantageously has a surface area greater than 90 m²/g. Preferably, the fumed silica advantageously has a surface area greater than 130 m²/g.

Next, the dispersion is rapidly diluted by the addition of de-ionized water. The additional water is then mixed into the aqueous dispersion in the mixer. The amount of water added is an amount sufficient to lower the concentration of fumed silica in the aqueous dispersion to the desired final concentration. Note, the pH of the solution during dilution is maintained, at all times, between 1 to 7. Preferably, the pH of the solution is 1.5 to 5.5.

Thereafter, the aqueous dispersion of fumed silica may be centrifuged or decanted, as desired. In addition, the aqueous dispersion of fumed silica may be passed through a filter to remove grit and any agglomerated fumed silica particles. In particular, any unwanted particles having a diameter greater than 1 micrometer is filtered. Thereafter, the filtered fumed silica may be packaged, as desired, for future use.

Hence, the fumed silica of the present invention is dispersed and diluted, at all times, at a pH of 1 to 7. Preferably, the pH is 1.5 to 5.5. In addition, the fumed silica advantageously has a surface area greater than 90 m²/g. Preferably, the fumed silica advantageously has a surface area greater than 130 m²/g.

Advantageously, the composition contains 0.5 to 9 weight percent oxidizer. Preferably, the oxidizer is in the range of 1 to 4 weight percent. Most preferably, the oxidizer is in the range of 2.5 to 3.5 weight percent. The oxidizing agent can be at least one of a number of oxidizing compounds, such as hydrogen peroxide (H₂O₂), monopersulfates, iodates, magnesium perphthalate, peracetic acid and other per-acids, persulfates, bromates, periodates, nitrates, iron salts, cerium salts, Mn (III), Mn (IV) and Mn (VI) salts, silver salts, copper salts, chromium salts, cobalt salts, halogens hypochlorites and a mixture thereof. Furthermore, it is often advantageous to use a mixture of oxidizer compounds. When the polishing slurry contains an unstable oxidizing agent such as, hydrogen peroxide, it is often most advantageous to mix the oxidizer into the slurry at the point of use. The preferred oxidizing agent is an iodate, including, its acids, salts, mixed acid salts, esters, partial esters, mixed esters, and mixtures thereof.

In addition to the oxidizer, the solution advantageously contains 0. 1 to 5 weight percent complexing agent to soften the passivating layer on tungsten. Preferably, the complexing agent is in the range of 0.5 to 3 weight percent. Most preferably, the complexing agent is in the range of 1 to 2 weight percent. Advantageously, the solution contains a “phosphorus-containing” compound as a complexing agent. A “phosphorus-containing” compound is any compound containing a phosphorus atom. A preferred phosphorus-containing compound is, for example, a phosphate, pyrophosphate, metaphosphate, hypophosphate, polyphosphate, phosphonate, including, their acids, salts, mixed acid salts, esters, partial esters, mixed esters, and mixtures thereof. In particular, a preferred aqueous polishing composition can be formulated using, for example, the following phosphorus-containing compounds: zinc phosphate, zinc pyrophosphate, zinc metaphosphate, zinc hypophosphate, zinc polyphosphate, zinc phosphonate, ammonium phosphate, ammonium pyrophosphate, ammonium metaphosphate, ammonium hypophosphate, ammonium polyphosphate, ammonium phosphonate, diammonium phosphate, diammonium pyrophosphate, diammonium metaphosphate, diammonium hypophosphate, diammonium polyphosphate, diammonium phosphonate, guanidine phosphate, guanidine pyrophosphate, guanidine metaphosphate, guanidine hypophosphate, guanidine polyphosphate, guanidine phosphonate, iron phosphate, iron pyrophosphate, iron metaphosphate, iron hypophosphate, iron polyphosphate, iron phosphonate, cerium phosphate, cerium pyrophosphate, cerium metaphosphate, cerium hypophosphate, cerium polyphosphate, cerium phosphonate, ethylene-diamine phosphate, piperazine phosphate, piperazine pyrophosphate, piperazine metaphosphate, piperazine hypophosphate, piperazine phosphonate, melamine phosphate, dimelamine phosphate, melamine pyrophosphate, melamine metaphosphate, melamine hypophosphate, melamine polyphosphate, melamine phosphonate, melam phosphate, melam pyrophosphate, melam metaphosphate, melam hypophosphate, melam polyphosphate, melam phosphonate, melem phosphate, melem pyrophosphate, melem metaphosphate, melem hypophosphate, melem polyphosphate, melem phosphonate, potassium phosphate, potassium pyrophosphate, potassium metaphosphate, potassium hypophosphate, potassium polyphosphate, potassium phosphonate, dicyanodiamide phosphate, urea phosphate, including, their acids, salts, mixed acid salts, esters, partial esters, mixed esters, and mixtures thereof. Also, phosphine oxides, phosphine sulphides and phosphorinanes of phosphonates, phosphites and phosphinates may be used, including, their acids, salts, mixed acid salts, esters, partial esters and mixed esters. A preferred phosphorus-containing compound is potassium pyrophosphate.

In addition to the complexing agent, the composition advantageously contains 0.1 to 5 weight percent of a chelating agent to minimize tungsten oxide polishing debris from building up on the pad. Preferably, the composition contains 0.5 to 3 weight percent of a chelating agent. Most preferably, the composition contains 1 to 2 weight percent of a chelating agent. Example chelating agents are carboxylic acids, including, their metal and non-metal salts. The chelating agent can have mono-, di-, tri-, or poly carboxylic groups attached to an open chain alkane (or its derivative) structure, or bonded to a ring structure. Examples of carboxylic acids include acetic acid, propionic acid, butyric acid, pivalic acid, oxalic acid, malonic acid, succinic acid, glutaric acid, adipic acid, benzoic acid, succinic acid, aspartic acid, gallic acid, gluconic acid, tannic acid and phthalic acid, and mixtures thereof. Preferred chelating agent is a α-hydroxy carboxylic acid (AHA), including, their metal and non-metal salts. An AHA is an organic acid containing a hydroxyl group on the carbon atom immediately adjacent to a carboxylic group. Examples of AHA include glycolic acid, lactic acid, tartaric acid, citric acid, malic acid, mandelic acid and salicylic acid, and mixtures thereof. A preferred AHA is lactic acid.

The compounds provide efficacy over a broad pH range in solutions containing a balance of water. This solution's useful pH range extends from at least 1 to 7. In addition, the solution advantageously relies upon a balance of deionized water to limit incidental impurities. The pH of the polishing fluid of this invention is preferably from 2 to 5, more preferably a pH of 3.5 to 4.5. The acids used to adjust the pH of the composition of this invention are, for example, nitric acid, sulfuric acid, hydrochloric acid, phosphoric acid and the like.

Optionally, the solution may contain by weight percent, 0.1 to 5 an additive to suppress the removal of the oxide. Preferably, the solution contains by weight percent, 0.5 to 3 of the oxide suppressant. Most preferably, the solution contains by weight percent, 1 to 2 of the oxide suppressant. Example additives include, ethylenediaminetetracetic acid and salts thereof, ethylene diamine, 1,4-diazabicyclo octane, ethylene glycol, crown ethers, catechol and gallol, citric acid, lactic acid, malonic acid, tartaric acid, succinic acid, malic acid, acetic acid and oxalic acid, amino acids, sulfamic acid, amino sulfuric acids, phosphoric acids, phosphonic acids, 2-quinoline carboxylic acid, and their salts. Further, example additives include, fluoride, flouboric acid, fluotitanic acid, hydrofluoric acid, fluosilicic acid, and their salts. In addition, polymeric additives such as polyacrylic acid, propylene oxide, polypyrilidone, polyethylene oxide and polyvinylalcohol may also be used.

Accordingly, the present invention provides an acidic aqueous composition useful for polishing tungsten and titanium on a semiconductor wafer comprising by weight percent 0.5 to 10 abrasive, 0.5 to 9 oxidizer, 0.1 to 5 complexing agent, 0.1 to 5 chelating agent and balance water, wherein the abrasive is fumed silica that has a surface area of greater than 90 m²/g and has only been exposed to an acidic pH.

### EXAMPLES

In the Examples, numerals represent examples of the invention and letters represent comparative examples. All example solutions contained, by weight percent, 3 potassium iodate, 1.5 potassium pyrophosphate and 1.5 lactic acid.

### Example 1

This experiment measured the selectivity of tungsten and titanium relative to TEOS on a semiconductor wafer. In particular, the effect of fumed silica that has only been processed at an acidic pH, on selectivity of tungsten and titanium relative to TEOS was tested. In other words, the fumed silica abrasive of Example 1 was not dispersed or diluted in a basic solution at any point during the preparation process. In addition, the effect of the surface area of the fumed silica on selectivity of tungsten and titanium relative to TEOS was tested. The solutions of Example 1 contained 3 weight percent fumed silica abrasive. An IPEC 472 DE 200 mm polishing machine using an IC1000™ polyurethane polishing pad (Rohm and Haas Electronic Materials CMP Technologies) under downforce conditions of about 5 psi, a polishing solution flow rate of 150 cc/min, a platen speed of 65 RPM and a carrier speed of 65 RPM planarized the samples. The polishing solutions had a pH of 4.0 adjusted with nitric acid. All solutions contained deionized water.

TABLE 1

| | Abra- | | | | | | |
|---|---|---|---|---|---|---|---|
| | sive | Abrasive | | | | Selec- | Selec- |
| | surface | processed | | | Ti | tivity | tivity |
| | area | entirely in | TEOS | W | (Å/ | (W/ | (Ti/ |
| Test | (m²/g) | acidic pH? | (Å/min) | (Å/min) | min) | TEOS) | TEOS) |
| A | 90 | Yes | 599 | 1937 | 4469 | 3.23 | 7.46 |
| B | 130 | No | 273 | 2023 | 4190 | 7.41 | 15.35 |
| 1 | 130 | Yes | 79 | 2340 | 4328 | 29.62 | 54.78 |
| 2 | 200 | Yes | 46 | 1120 | 4661 | 24.35 | 101.33 |

As illustrated in Table 1 above, the acidic pH-only treated abrasive effects the selectivity of the composition. In particular, the addition of the acidic fumed silica having a surface area of greater than 90 m²/g improved the selectivity of the compositions for tungsten and titanium relative to the TEOS. For example, Test 1 provided an increased selectivity of 29.62 and 54.78 for tungsten and titanium, respectively, from 3.23 and 7.46 for tungsten and titanium, respectively, in comparative Test A, when the surface area was increased from 90 m²/g to 130 m²/g. Similarly, Test 1 provided an increased selectivity for tungsten and titanium from 7.41 and 15.35 for tungsten and titanium, respectively, in comparative Test B, when the abrasive was entirely processed in an acidic pH. Also, the increased surface area from 90 m²/g to 130 m²/g in Test A to Test 1 suppressed the TEOS removal rate from 599 Å/min to 79 Å/min. Further, the increased surface area from 90 m²/g to 200 m²/g in Test A to Test 2 suppressed the TEOS removal rate from 599 Å/min to 46 Å/min. Tests 1 and 2 provided excellent removal of titanium.

Accordingly, the present invention provides an acidic aqueous composition useful for polishing tungsten and titanium on a semiconductor wafer comprising by weight percent 0.5 to 10 abrasive, 0.5 to 9 oxidizer, 0.1 to 5 complexing agent, 0.1 to 5 chelating agent and balance water, wherein the abrasive is fumed silica that has a surface area of greater than 90 m²/g and has only been exposed to an acidic pH.

1. An acidic aqueous composition useful for polishing tungsten and titanium on a semiconductor wafer comprising by weight percent 0.5 to 10 abrasive, 0.5 to 9 oxidizer, 0.1 to 5 complexing agent, 0.1 to 5 chelating agent and balance water, wherein the abrasive is fumed silica that has a surface area of greater than 90 m²/g and has only been exposed to an acidic pH.

2. The composition of claim 1 wherein the abrasive has a surface area of greater than 130 m²/g.

3. The composition of claim 1 wherein the oxidizer is an iodate, including, its acids, salts, mixed acid salts, esters, partial esters, mixed esters, and mixtures thereof.

4. The composition of claim 1 wherein the complexing agent is selected from the group comprising: phosphate, pyrophosphate, metaphosphate, hypophosphate, polyphosphate, phosphonate, including, their acids, salts, mixed acid salts, esters, partial esters, mixed esters, and mixtures thereof.

5. The composition of claim 1 wherein the chelating agent is a carboxylic acid, including, their salts and mixtures thereof.

6. The composition of claim 1 wherein the aqueous composition has a pH of 3.5 to 4.5.

7. An acidic aqueous composition useful for polishing tungsten and titanium on a semiconductor wafer comprising by weight percent 0.5 to 10 abrasive, 0.5 to 9 iodate oxidizer, 0.1 to 5 potassium pyrophosphate, 0.1 to 5 lactic acid and balance water, wherein the abrasive is fumed silica that has a surface area of greater than 90 m²/g and has been dispersed and diluted entirely in an acidic pH.

8. The composition of claim 8 wherein the abrasive has a surface area of greater than 130 m²/g.

9. A method useful for polishing tungsten and titanium on a semiconductor wafer comprising:
contacting the tungsten and titanium on the wafer with an acidic polishing composition, the polishing composition comprising by weight percent 0.5 to 10 abrasive, 0.5 to 9 oxidizer, 0.1 to 5 complexing agent, 0.1 to 5 chelating agent and balance water, wherein the abrasive is fumed silica that has a surface area of greater than 90 m²/g and has only been exposed to an acidic pH; and
polishing the tungsten and titanium with a polishing pad.

10. The method of claim 1 wherein the abrasive has a surface area of greater than 130 m²/g.
